(19) United States
(12) Patent Application Publication
(10) Pub. No.: US 2023/0106126 A1
(43) Pub. Date: Apr. 6, 2023

(54) CARGO TRANSPORT SYSTEM

(71) Applicant: Stratom, Inc., Boulder, CO (US)

(72) Inventors: Ross Wehner, Boulder, CO (US); Ryan Marsini, Frederick, CO (US); Ryan Delgizzi, Arvada, CO (US); Mark Gordon, Lafayette, CO (US); Jesse Weifenbach, Thornton, CO (US); David Regan, Arvada, CO (US)

(21) Appl. No.: 18/075,616

(22) Filed: Dec. 6, 2022

Related U.S. Application Data
(63) Continuation of application No. 17/752,655, filed on May 24, 2022.
(60) Provisional application No. 63/192,926, filed on May 25, 2021.

(51) Int. Cl. B60P 1/36; B60S 9/10; B66F 9/06; B66F 9/19; B66F 9/075; B62D 55/065

(52) U.S. Cl. CPC B60P 1/36; B60S 9/10; B66F 9/063; B66F 9/195; B66F 9/07559; B62D 55/065

(57) ABSTRACT

A cargo transport system is provided that has an ability to move cargo in an autonomous or semi-autonomous manner, using a compact lift vehicle capable of lifting relatively heavy objects. The system includes a cargo loading system, a sensor suite coupled with a controller, dunnage detection, cross-decking capability, cargo stacking capability, autonomous navigation, tip detection and prevention, or any combinations thereof. The system may include a fork assembly coupled with a mast and movable in a vertical direction relative to the mast. Further, the mast may be coupled with a platform or deck and movable in a horizontal direction relative to the platform, to allow the fork assembly to be lowered below a top plane of the platform when the mast is at a forward location relative to the platform. The controller and sensor suite and may provide for autonomous or semi-autonomous control and movement of the cargo transport system.

### CROSS-REFERENCE TO RELATED APPLICATIONS

The present Application claims priority to U.S. Provisional Pat. Application No. 63/192,926 by Wehner et al., entitled “CARGO TRANSPORT SYSTEM,” filed May 25, 2021, and U.S. Pat. Application Serial No. 17/175,655 by Wehner et al., entitled “CARGO TRANSPORT SYSTEM,” filed May 24, 2022, each of which are assigned to the assignee hereof, the entire disclosure of which are incorporated herein by reference.

### STATEMENT REGARDING FEDERALLY SPONSORED RESEARCH OR DEVELOPMENT

This invention was made with Government support under SBIR Contract Numbers M67854-19-P-6619 and M67854-19-P-6619 P00001; contracted through the United States Marine Corps. The Government may have certain rights to this invention.

### FIELD

The present disclosure is directed to cargo handling systems and, more specifically, to a cargo transport system including a pallet loader with sliding forklift and anti-tip system.

### BACKGROUND

Movement of materials and equipment is a significant and important component of any supply and distribution chain. Materials and equipment are routinely required to be transported many times throughout their life cycle. As such, many transport systems have been developed to help efficiently move items (referred to generally as “cargo” herein) through various different modes of transportation, including transport by road vehicles, rail vehicles, aircraft, and watercraft. For example, forklifts are commonly used in cargo and material transport, such as exemplary forklifts 100 and 200 illustrated in FIGS. 1 and 2, respectively. Efficient machinery for moving materials and equipment in various transport systems is desirable, which may reduce labor involved in cargo transport, and enhance safety and reliability for movement of cargo.

### SUMMARY

Various aspects of the present disclosure provide a cargo transport system that provides the ability to move cargo in an autonomous or semi-autonomous manner, using a relatively compact lift vehicle capable of lifting relatively heavy objects in a variety of situations. In some aspects, the cargo transport system is designed to operate autonomously or remotely to move cargo between desired locations. The system may navigate over rough terrain while carrying heavy loads through the use of a track-based propulsion system, although wheel-based systems may also be used. The system, in some aspects, provides a cargo loading system, dunnage detection, cross-decking capability, cargo stacking capability, autonomous navigation, tip detection and prevention, or any combinations thereof. In some examples, a fork assembly may be coupled with a mast and movable in a vertical direction relative to the mast. Further, the mast may be coupled with a platform or deck and movable in a horizontal direction relative to the platform. In some cases, the fork assembly may be lowered below a top plane of the platform when the mast is at a forward location relative to the platform to be in position to lift cargo that is resting at a ground (or other surface) level. In some cases, an anti-tip system may include one or more supports coupled with the platform and movable to be in front of the platform (e.g., by rotating or extending a support arm away from the platform, etc.) when the mast is located at the forward location relative to the platform. In some cases the anti-tip system may include one or more pressure sensors that may be used, alone or in conjunction with tip sensors or pressure sensors associated with a propulsion system (e.g., tracks or wheels), for load and stability monitoring when lifting and moving cargo.

Thus, in accordance with various aspects discussed herein, the cargo transport system provides a forklift-type vehicle that is designed to autonomously carry especially heavy and/or bulky loads across a wide range of terrain. Similar to a traditional forklift, the system is designed to manipulate (pick up, transport, and drop off) palletized cargo, or other cargo that is capable of being moved with a forklift, using traditional forklift tines. In some cases, the vehicle may be configured to transport military aircraft cargo packed on pallets across airfields, but is compatible with numerous other types of cargo and environments as well. In some aspects, the cargo transport system has autonomous functions that include identifying cargo located on dunnage on the ground, properly positioning the vehicle relative to the cargo on the ground, picking up the cargo, autonomously transporting cargo across a wide range of terrain, and delivering it either by cross-decking or placement on the ground. The cargo transport system may also be capable of autonomously driving into cargo aircraft with cargo aboard the vehicle, so that both may be flown to a new destination. The cargo transport system may also perform the reverse of these activities to unload aircraft as well.

In some aspects, a method for cargo transport is provided in which a cargo transport system having a suite of sensors may detect cargo that is to be moved. In some cases, the cargo detection may be based on optical sensors, radar, ultrasonic sensors, rangefinders, LIDAR, or any combinations thereof. In some cases, the cargo may be located on dunnage (e.g., integrated dunnage on a pallet or separate dunnage that is located beneath the cargo or a pallet), and the suite of sensors may detect a location of the dunnage. In some cases, one or more sensors located on one or more forks of the cargo transport system may detect a location of the end of the respective fork relative to the dunnage and cargo, and may provide the information to a controller to allow for proper placement of the forks relative to the cargo. In some cases, cargo characteristics may be preconfigured at the controller, such as dimensions and weight of the cargo, which may be used to determine the proper placement of the forks relative to the cargo. In other cases, sensed characteristics of the cargo and dunnage may be used to determine the proper placement of the forks relative to the cargo. The controller may receive information from the sensor suite, position the forks relative to the cargo, and lift the cargo for transport. With the cargo lifted, the controller may engage a propulsion system to move the cargo transport system to a desired destination for the cargo. In some cases, the controller may use waypoints to move the cargo. In some cases, the controller may use inputs from the sensor suite to identify a transport path for the cargo autonomously (e.g., without preset waypoints). In other cases, the controller may provide information from the sensor suite to a remote location (e.g., remote controller or operator), and may receive commands for movement from the remote location. In some cases, the sensor suite may provide pressure or sensed weight information from one or more locations on the system to the controller, that may be used to adjust a location of the forks, adjust an anti-tip system, adjust one or more suspension characteristics of the propulsion system, trigger a warning to an operator, or any combinations thereof. In some cases, the cargo may be lifted and moved onto a top platform of the cargo transport system, and the cargo transport system and cargo may be transported together.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

FIGS. 1 and 2 are illustrations of common conventional forklifts, which are commonly used in cargo transport operations;

FIGS. 3 through 5 are illustrations of a cargo transport system of various aspects of the present disclosure;

FIG. 6 shows an exemplary powered roller that is associated with a fork assembly of the cargo transport system of various aspects of the disclosure;

FIG. 7 shows a side view of the cargo transport system in various different states for moving and transporting cargo;

FIG. 8 shows exemplary subcomponents or subsystems of the cargo transport system of various aspects of the disclosure;

FIGS. 9 through 11 illustrate sensor assemblies associated with the cargo transport system for autonomous or semi-autonomous transport of cargo in accordance with various aspects of the disclosure;

FIG. 12 shows an exemplary process flow for detection and lifting of cargo in accordance with various aspects of the disclosure;

FIGS. 13 through 15 show exemplary cargo transport including ramp-loading, cross-decking, and autonomous cargo stacking of various aspects of the disclosure;

FIGS. 16A and 16B show a cargo transport system with a reduced footprint and an exemplary use in aircraft loading for cargo transport operations in accordance with various aspects of the disclosure;

FIGS. 17 and 18 show exemplary mechanical aspects of the cargo transport system of various aspects of the disclosure;

FIGS. 19 and 20 show exemplary sensors of the cargo transport system of various aspects of the disclosure; and

FIGS. 21 through 34 show exemplary mechanical aspects the cargo transport system of various aspects of the disclosure.

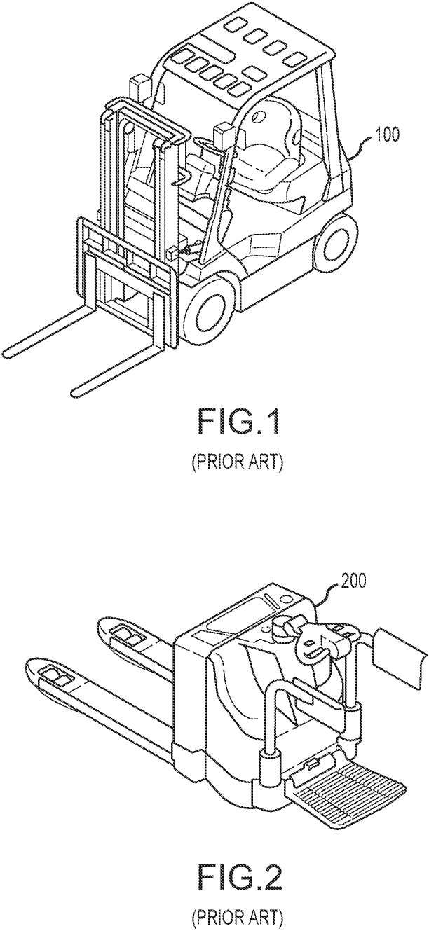

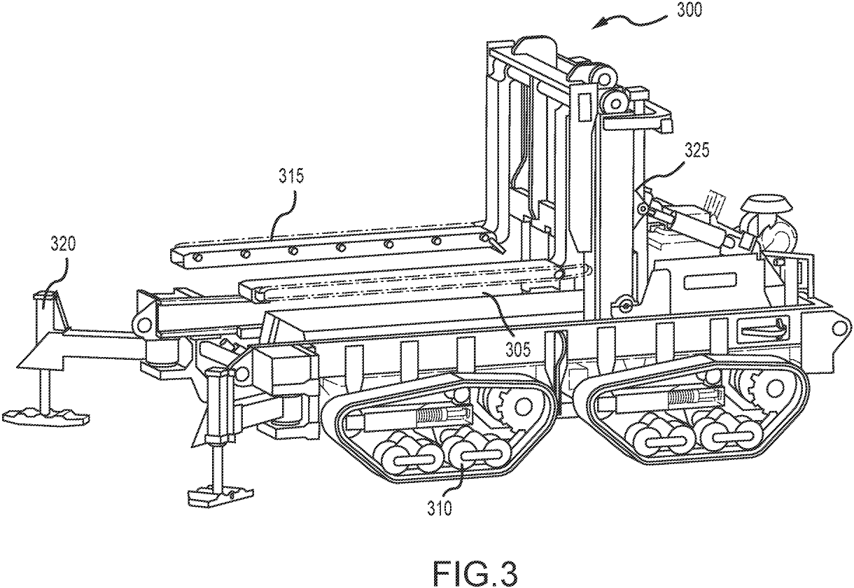

### DETAILED DESCRIPTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements. Thus, various implementations of techniques and components as discussed herein may omit, substitute, or add various procedures or components as appropriate. For instance, aspects and elements described with respect to certain examples may be combined in various other examples. It should also be appreciated that the following systems, devices, and components may individually or collectively be components of a larger system, wherein other procedures may take precedence over or otherwise modify their application.

Various examples disclosed herein provide a cargo transport system that is self-propelled and interacts with one or more control systems. The cargo transport system of various aspects is a self-propelled cargo transport system vehicle (e.g., using an electric motor, internal combustion engine, fuel cell, or any combinations thereof) that is designed to move cargo in various different settings autonomously, semi-autonomously, or teleoperatively (e.g., by remote control). In some cases, the cargo transport system may use hydraulic propulsion with a hybrid electric and gasoline or diesel engine providing power to a hydraulic system. In some cases, the cargo transport system may use an all-electric propulsion system in which one or more electric motors are powered by a rechargeable battery, an on-board generator, or combinations thereof. In some cases, the cargo transport system maintains compatibility with one or more different military cargo transports (e.g., aircraft, ship, vehicle, etc.) such as, for example, current military CH-53 and V-22 aircraft. In other examples, the system may be compatible other aircraft such as military C-17, C-130, or Boeing 747 aircraft, or may be compatible with commercial Boeing 737,747, 757, or 767 aircraft, Airbus A300 aircraft, or McDonnell Douglas MD-11-type aircraft. Further, the cargo transport system may be compatible with ground-based transports (e.g., cargo trucks, trailers, shipping containers, etc.) or maritime-based transports (e.g., military or commercial maritime vessels). Such systems provide a compact vehicle with an advanced ability to autonomously or semi-autonomously move cargo in congested, dynamic, environments of warehouses, aircraft decks, shipboards, outdoor settings, landing zones, airports, and the like, with relatively little operator involvement.

As mentioned above, various aspects are described herein with respect to specific mechanical designs compatible with current military cargo transports. However, as will be readily apparent to those of skill in the art, the cargo transport system as discussed herein may be used in numerous other commercial, industrial, and military settings having different cargo handling specifications. In some cases, the cargo transport system utilizes a tracked propulsion system to provide vehicle motion in space constrained environments that may be unimproved to provide off-road capable cargo transport in unimproved environments, in addition to supporting the ability to load/unload cargo aircraft. The system, in some examples, may be used in a variety of situations that require moving heavy loads, such as delivery of cargo to remote locations, for transportation of supplies (water, food, etc.), or for construction to move around heavy building components, to name but a few examples. Further, the cargo transport system may also provide the ability to navigate indoor or outdoor environments, or both. For example, the cargo transport system may provide for autonomous or semi-autonomous movement of cargo through indoor/outdoor thresholds of warehouses, and autonomous or semi-autonomous movement of cargo between disparate warehouse buildings.

To operate autonomously and safely, the cargo transport system of various aspects utilizes a suite of sensors to detect its surroundings to include detection of obstacles (to include people, vehicles, boxes, walls, etc.), perform collision avoidance of obstacles, and determine its location indoors, outdoors, and within a cargo transport. Such sensors may include, for example, positioning sensors, Global Positioning System (GPS) sensors, inertial measurement units (IMUs), proximity detectors, cameras, stereographic imaging sensors, ultrasonic sensors, 3D flash LIDAR systems, LIDAR systems, and 3D Time of Flight (TOF) cameras, to name a few. As used herein, the term dense 3D sensor units may be used to refer to units that may provide data that may be used for 3D sensing around a cargo system, such as stereographic imaging sensors, ultrasonic sensors, 3D flash LIDAR, LIDAR, radar, and cameras coupled with image processing and recognition, for example. Further, aspects discussed herein may also have cargo detection and identification sensors, such as sensors (e.g., optical, radar, and ultrasonic sensors or rangefinders, etc.) that are located at the tip of each fork and/or adjacent to a mast that may be used to detect fork and vehicle location relative to cargo or dunnage.

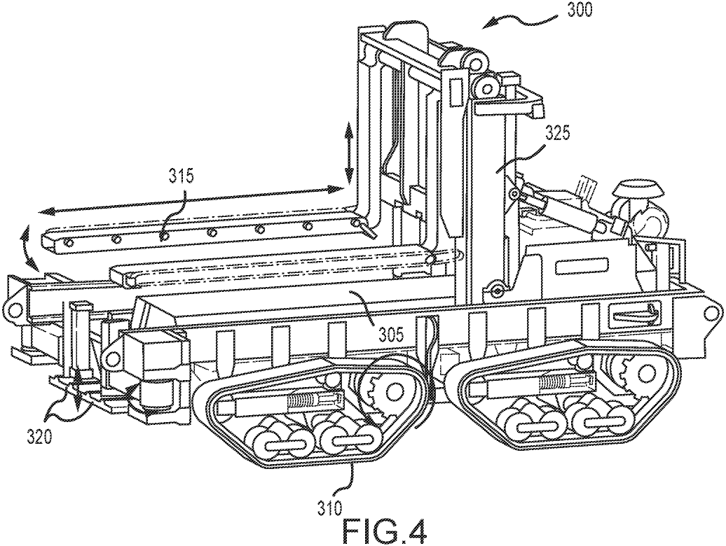

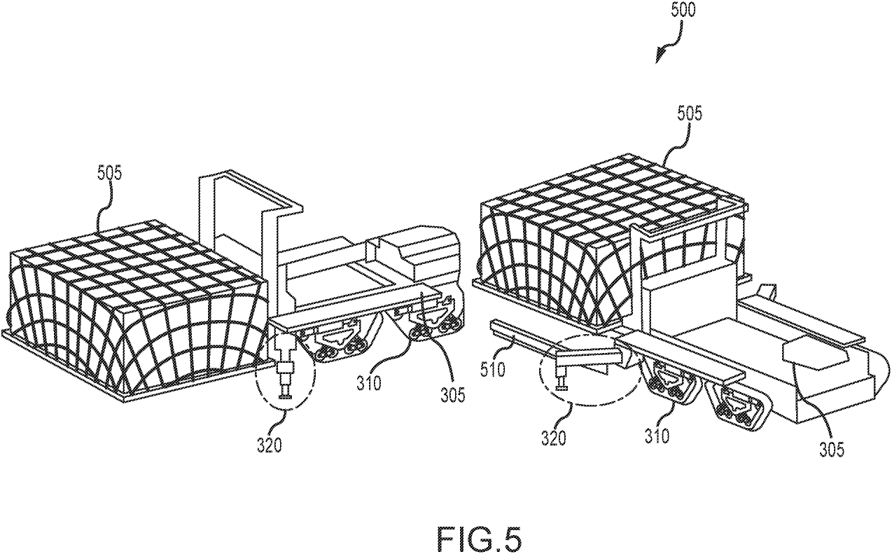

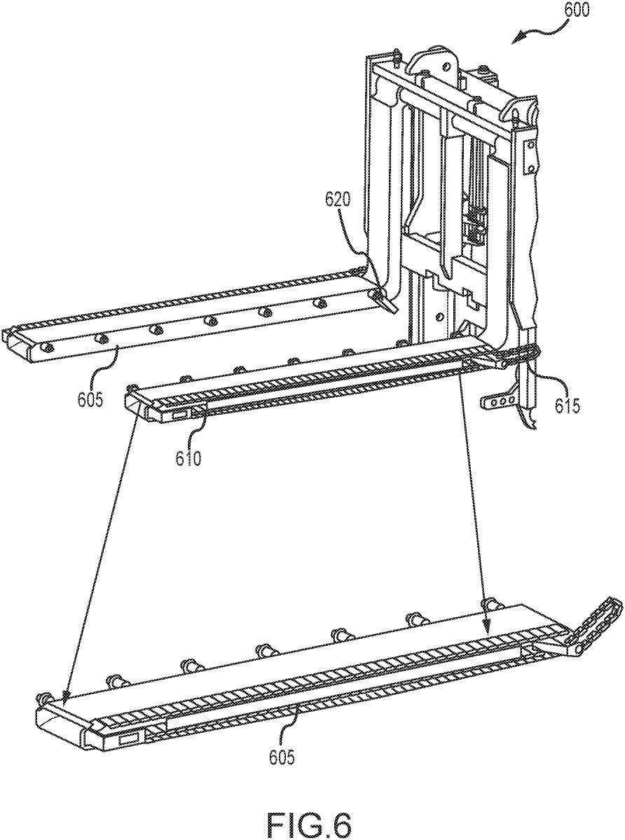

With reference now to FIGS. 3-5, an example of a cargo transport system 300 is illustrated. In this example, the system includes four propulsion units 310 attached to a main chassis with a platform 305 (or deck), having a top surface that is generally parallel with a fork assembly 315. Anti-tip supports or “outriggers” 320 may be mounted to a front portion of the main chassis may autonomously pivot outward to provide support when the fork assembly 315 and mast 325 are moved to the front of the platform 305 to pick up cargo 505 (which may be placed on dunnage 510 or have integrated dunnage such as is common on some types of pallets), such as is illustrated in the example 500 of FIG. 5. As illustrated in FIG. 4, the fork assembly 315 and mast 325 may slide relative to the platform 305 and raise and lower relative to the mast 325. In some cases, a powered roller assembly be located on each of the forks of the fork assembly 315, as will be discussed in more detail below.

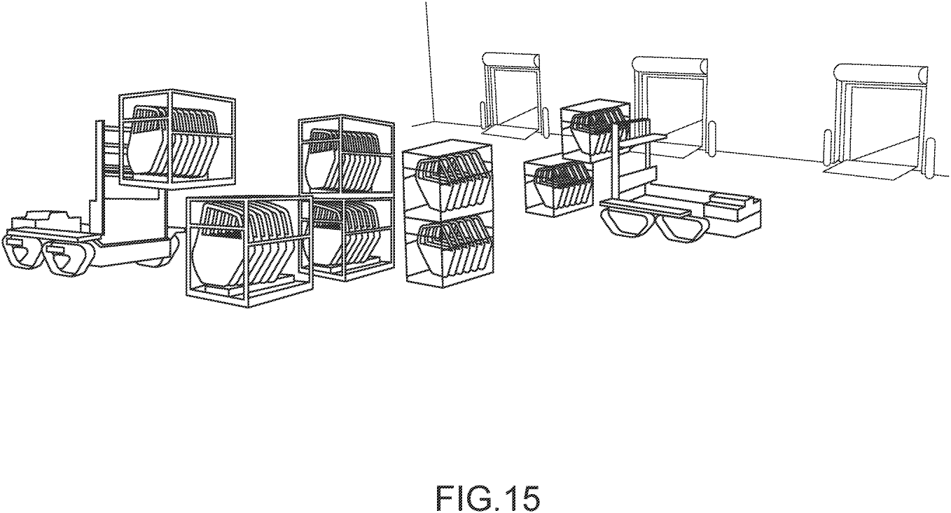

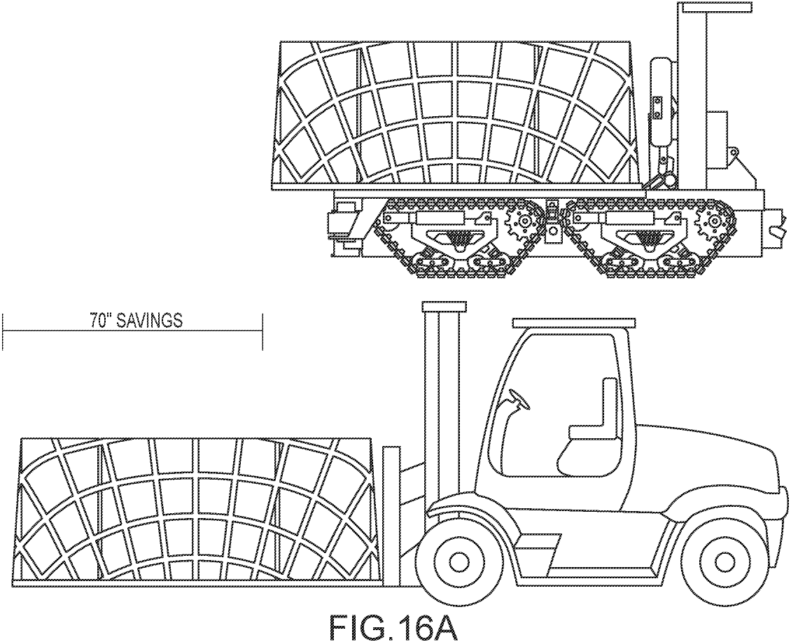

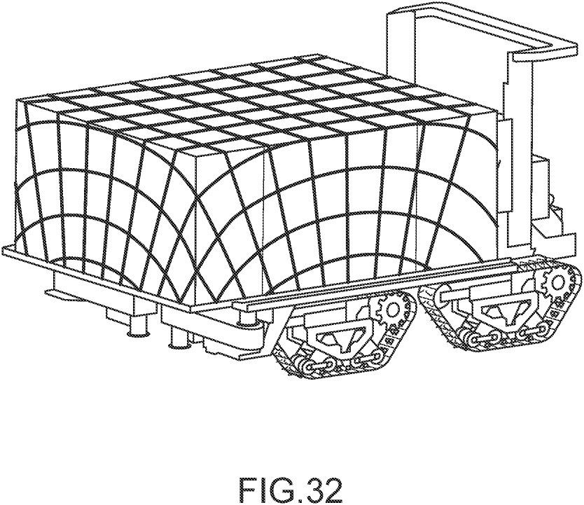

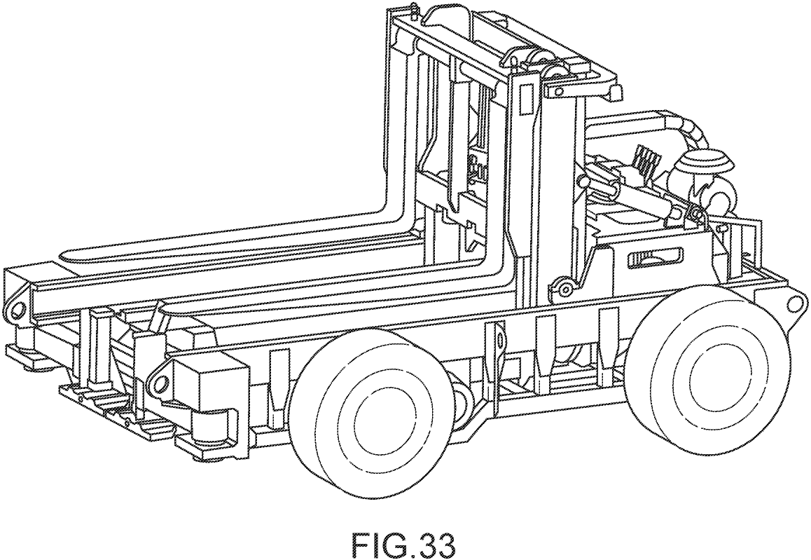

While various examples illustrated and discussed herein show four tracked propulsion units 310, in some cases, the system may be constructed with only two propulsion units if desired, with more than four propulsion units, with wheels rather than tracks (with some or all of the wheels or tracks powered). Cargo 505 may be palletized cargo such as illustrated in FIG. 5 (or other cargo such as illustrated in FIGS. 14 and 15), which may be lifted by the fork assembly 315 and moved onto the platform 305 for transport to a different location, and then moved off the platform 305 and onto the ground or other surface (e.g., aircraft or conveyer system in a cross-decking implementation). In some cases the cargo 505 may not be moved onto the platform 305 prior to movement of the vehicle, such as in cases where the cargo 505 is light enough to safely move without the fork assembly 315 and mast 325 being located at the rear portion of the platform 305 (e.g., based on pressure sensor or tilt sensor feedback, based on a compression state of a suspension of the front propulsion units 310, based on a differential between compression states of front/rear propulsion units 310, etc.). The cargo transport system 300 according to this aspect of the disclosure is a skid-steer locomotion based system designed for the purpose of material handling on unimproved as well as improved terrain, and reduces the contact pressure on driving surfaces which may be useful for certification for the vehicle to fly as cargo on aircraft. While several examples herein are directed to tracked systems, various aspects discussed herein are equally applicable to a system that uses wheels, such as a wheeled vehicle configured as a skid-steer type vehicle or a vehicle that uses Ackermann steering such as illustrated in FIG. 33. Wheeled vehicles may operate using the various techniques as discussed herein, and may be deployed in cases where driving surfaces are more improved (e.g., asphalt or concrete surfaces, or decking surfaces made of wood, composite materials, or metal), or may withstand relatively higher contact pressure. Continuing with the examples directed to tracked systems, such systems may provide an independent tracked skid-steer vehicle, and each tracked propulsion unit 310 can be controlled independently (e.g., using a Controller Area Network (CAN) framework and a central processor). Messages may be sent to and from the propulsion unit 310 motor controllers to control wheel speed/torque and status. The cargo system 300 may provide capabilities to load and unload cargo 505 autonomously or teleoperatively, as mentioned above. In some examples, the platform 305, with the mast 325 located at a rearmost position, may be configured to hold a 463L half pallet or two standard cargo pallets as shown in FIG. 32.

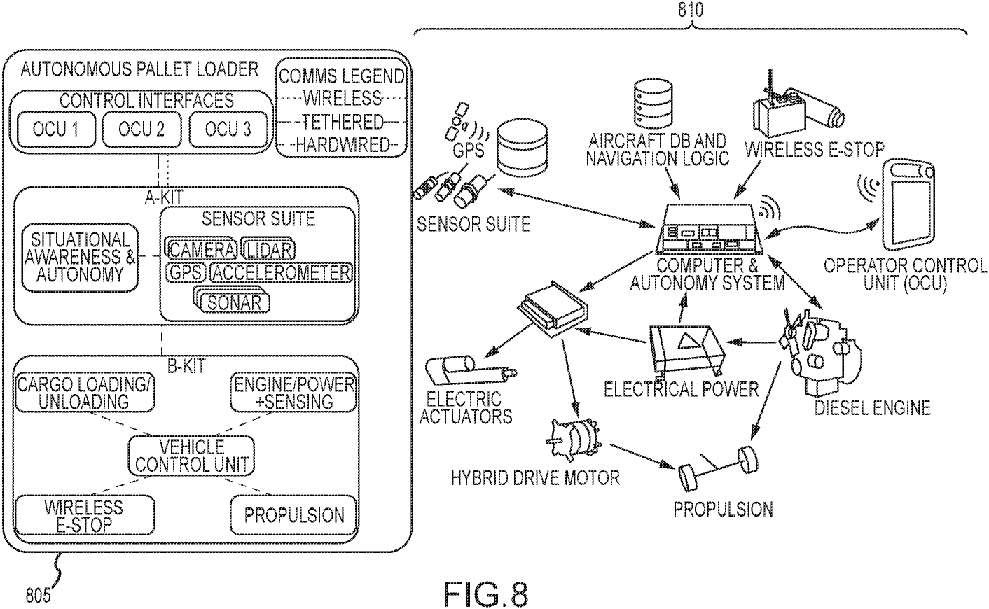

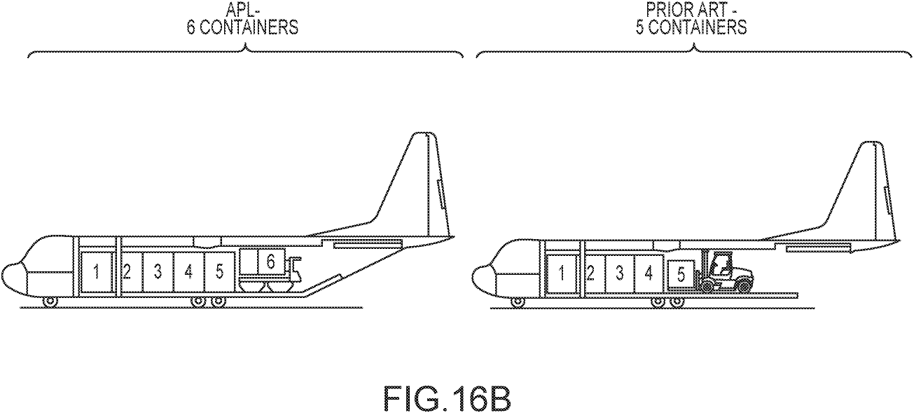

As shown in FIGS. 3-5, a readily deployable anti-tip system (ATS) including anti-tip supports 320 may enable the vehicle to lift loads that are heavier than the vehicle’s mass by shifting the vehicle’s tipping point several feet forward. Such features allow the vehicle to be relatively lightweight compared to traditional forklift vehicles with similar payload capacities. The ATS in some cases, provides for rotation deployment of the anti-tip supports 320 and retraction thereof autonomously when the vehicle is positioning to raise or lower cargo (e.g., as illustrated in FIG. 7 as movement 710). The fork assembly 315 that is slidable on the top plate platform 305 to enable the entire forklift assembly to slide across the top of the vehicle (e.g., as illustrated in FIG. 7 as movement 705), in combination with the ATS, allows for a reduced footprint of the vehicle while flying as aircraft cargo and enables the vehicle to carry cargo on top of itself while flying as aircraft cargo - further improving the aircraft cargo carrying capacity while also transporting a forklift vehicle. In some cases, while the fork assembly 315 is located above the top plate of platform 305, it may also raise and lower (e.g., as illustrated in FIG. 7 as movement 715), which may enable additional cross-decking flexibility, for example. An example of relative footprint reduction compared to a traditional forklift is shown in FIG. 16A, and an example of additional aircraft cargo capacity using a system as described herein is shown in FIG. 16B.

Each propulsion unit 310, in some examples, may include a motor, suspension, a hydraulic system used to propel, raise, and lower the chassis, and a controller to control operation of the unit. In some examples, each propulsion unit may include a suspension spring (e.g., one or more coil springs, leaf springs, torsion springs, or any combinations thereof) for shock absorption and a hydraulic cylinder to provide height manipulation. In some examples, the system uses motor controllers (e.g., CANopen controllers) to communicate between each propulsion unit controller and a master computing system. The motors in some examples may be driven by a fully hydraulic system, or electrically using a battery system (e.g., a 48 V rechargeable battery system) and/or generator (e.g., internal combustion engine, fuel cell, photovoltaic system, etc.). The controller at each propulsion unit may respond to speed and torque commands from the master computing system or master controller and power the drive motors responsive to the commands. The propulsion units 310 may be mounted to the side or the bottom of the chassis using bolts, and each propulsion unit 310 may include an emergency stop button. In some examples, one or more of the propulsion units 310 may include sensors for use in control operations, such as positioning sensors, rotational sensors, speed sensors, encoders, and the like.

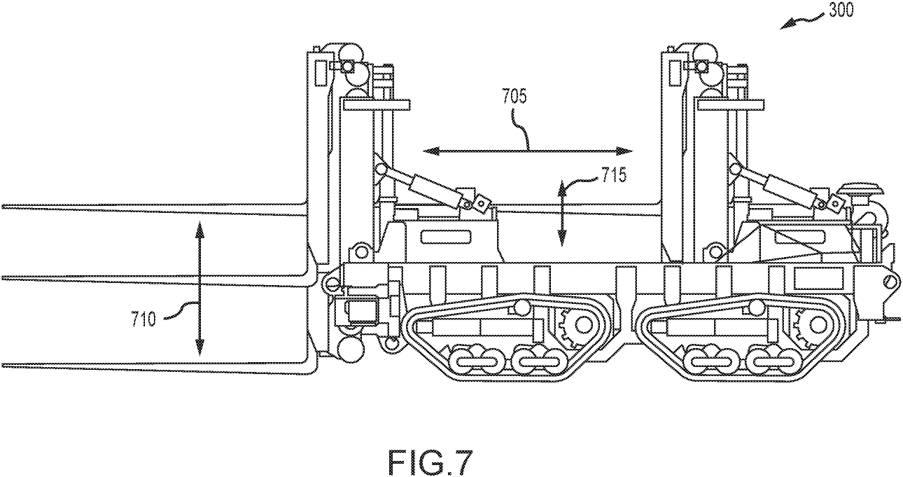

FIG. 6 illustrates the fork and mast assembly 600, which in some examples may include powered roller assembly 605 that is coupled with each fork 610 of the cargo transport system. The powered roller assembly 605 may have a drive motor and chain 615, which may move a conveyer chain with rubber pads in some examples to allow for moving of the cargo when on the fork assembly. A mechanism 620 may be provided that secures the powered roller assembly to the fork assembly. In some cases, the powered roller assembly 605 may be used to load and unload cargo onto and off of the forks in cross-decking or cross-loading operations for cargo handling onto and off of aircraft or warehouse conveyer systems. In some cases, when the forks are located at a proper position for cross-decking, the powered roller assembly 605 may activate autonomously to move cargo onto or off of the forks.

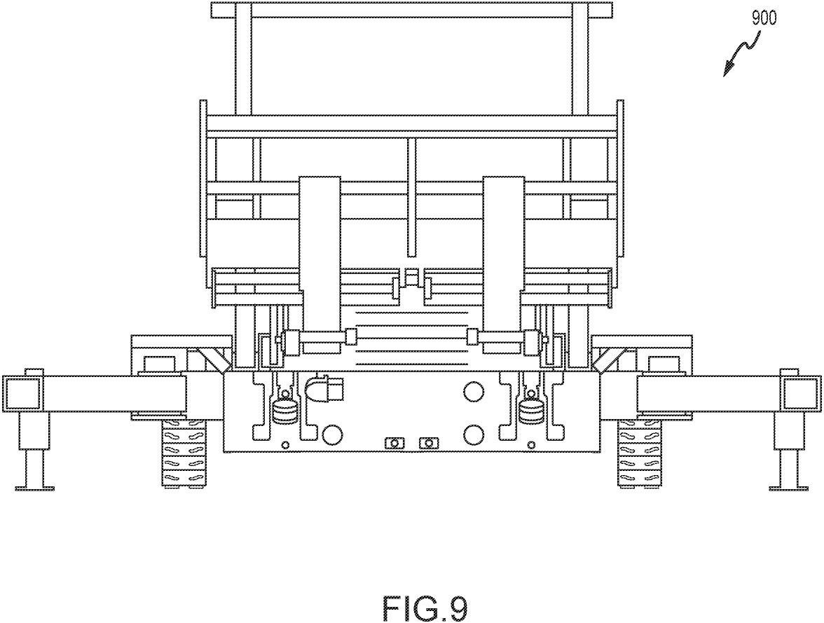

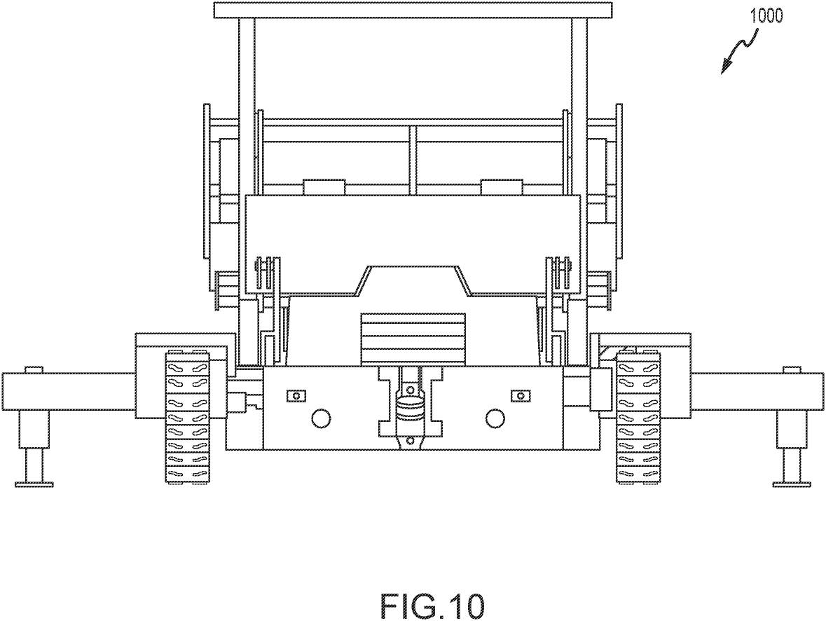

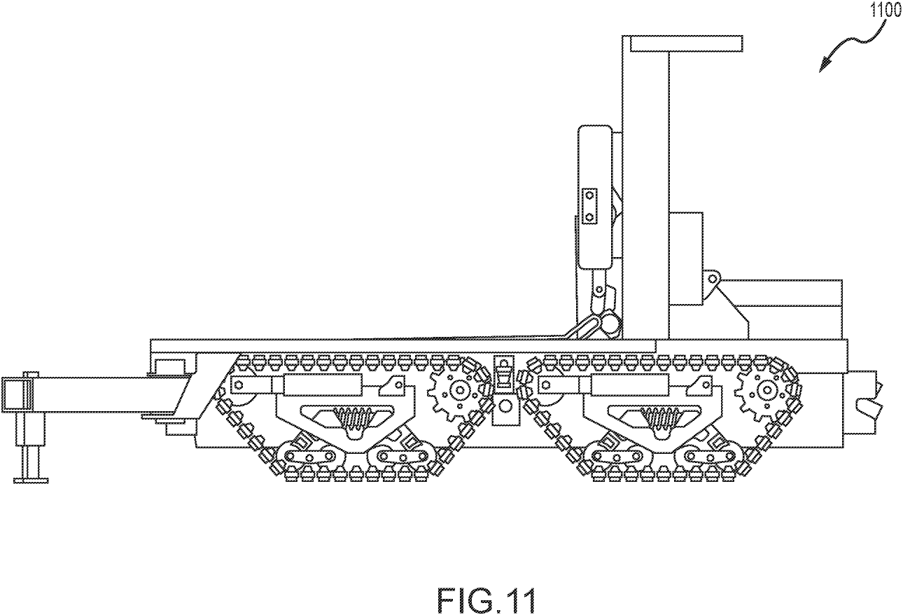

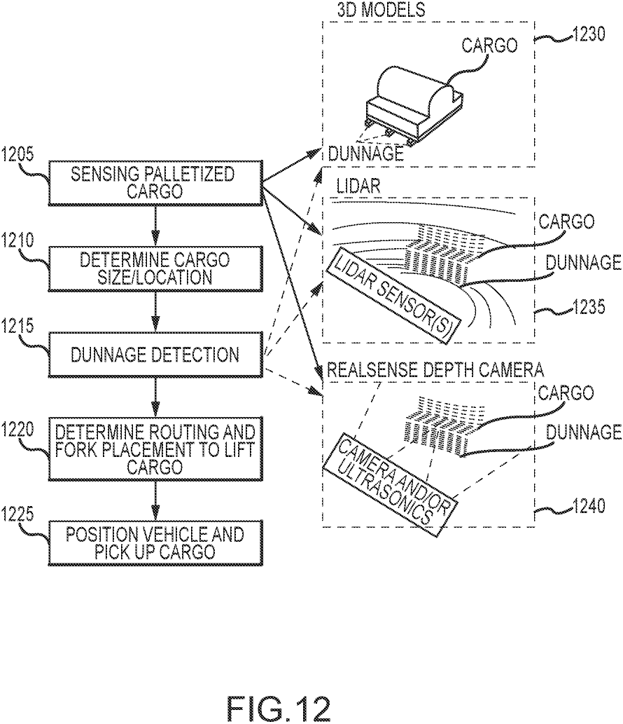

FIG. 8 illustrates exemplary functional components of a cargo transport system of some aspects of the disclosure, including a control system 805 and functional components 810. As illustrated in FIG. 8, the control system architecture 805 may include a number of control interfaces (e.g., for operator control or programming of the vehicle), an autonomy kit (A-kit) subsystem that provides situational awareness and autonomy based on desired cargo movement (e.g., as received from the control interface(s)) and information from a sensor suite (e.g., one or more cameras, LIDAR(s), a global positioning system (GPS) module (alone or in combination with one or more other positioning components), accelerator(s), sonar(s), etc., or any combinations thereof). The control system 805 may also include a by-wire (B-kit) subsystem that provide control through a vehicle control unit for cargo loading/unloading, engine/power sensing, propulsion, wireless and/or integrated emergency stop control, or any combinations thereof. The A-kit and B-bit subsystems may be part of a computer and autonomy system that is coupled with the sensor suite, a database of aircraft and navigation logic, emergency stop (e-stop) controls, operator control unit(s), an internal combustion engine (e.g., a diesel engine), an electrical power system (e.g., battery system and associated charging and control components), electric actuators (e.g., associated with the fork and mast assembly), a hybrid motor drive, and the propulsion system. FIGS. 9 through 11 show exemplary locations on vehicles 900, 1000, and 1100, respectively, of various sensors, status indicators, and data and power ports (e.g., data and power or charging ports that comply with standards established by the North Atlantic Treaty Organization (NATO)), at the front, rear, and sides of the vehicle.

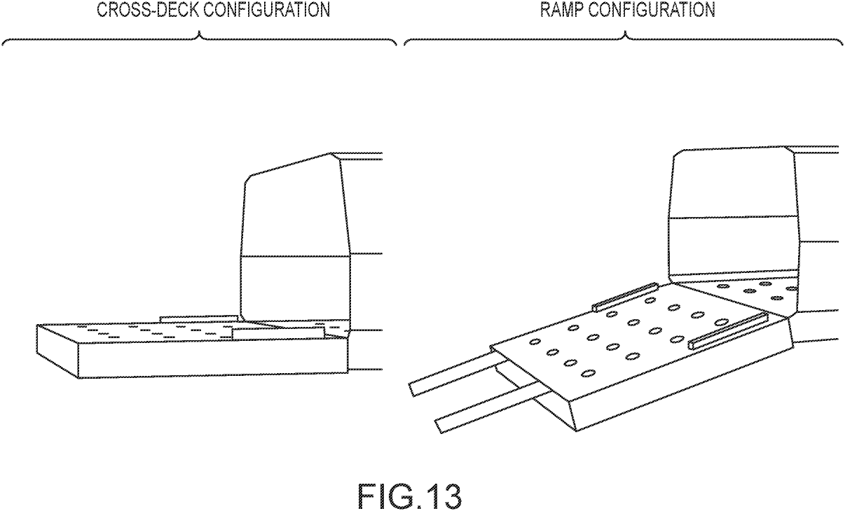

FIG. 12 illustrates a process flow for autonomous or semi-autonomous vehicle operation in accordance with aspects of the disclosure. In this example, at 1205, the vehicle may sense palletized cargo. The sensing of palletized cargo may use a one or a combination of sensors of the sensor suite, that may be used to generate a 3D image of the cargo that may be compared to 3D models 1230 to classify the cargo and detect proper lift orientation and lift points. In this example, the cargo is on a pallet that is located on dunnage, although non-palletized cargo may also be handled in other cases. LIDAR sensing 1235 and optical sensing 1240 may be used to sense the presence of the cargo, pallet, and dunnage, and may be used in conjunction with the 3D models 1230 to sense the cargo. In some cases, a cargo frame, pallet, dunnage, or any combinations thereof, may include optical or electronic markers that may be used in cargo sensing (e.g., a predefined optical/electronic target that may attached to the cargo, pallet, or dunnage that indicates an end/orientation of the object). In some cases, an optical or electronic marker (e.g. a QR code or bar code) may indicate a type of cargo or identification of the cargo that may be used for cargo sensing, identification physical cargo characteristics (e.g., weight/height/length, etc.), inventory tacking, and the like. At 1210, the vehicle may determine the cargo size and location based on the sensing of the cargo, using any of the inputs as discussed.

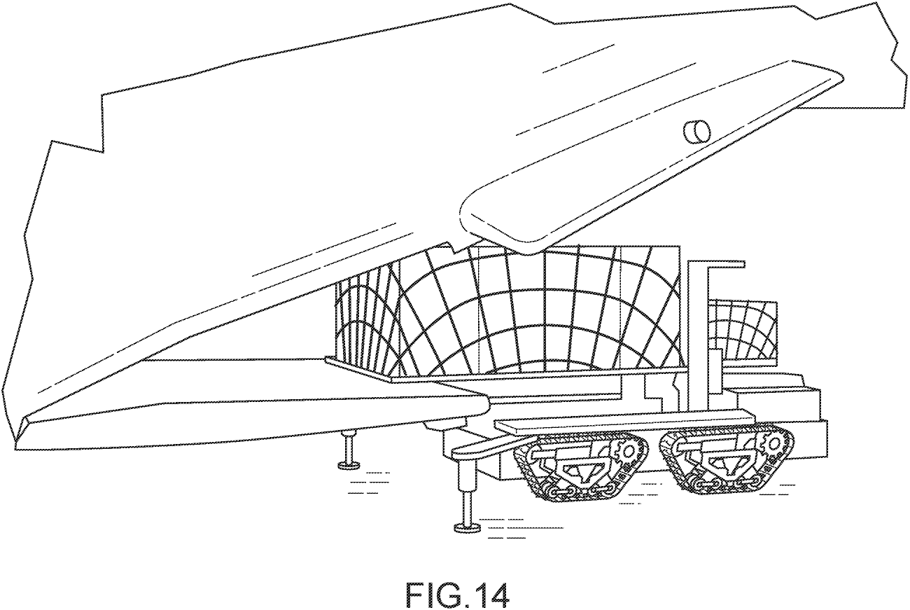

At 1215, optionally, the vehicle may identify dunnage associated with the cargo. In some cases, LIDAR and optical inputs may be used to sense dunnage under palletized cargo with sufficient accuracy to enable the vehicle to autonomously pick-up cargo off of the dunnage. In some cases, sensors may be placed at the end of the forklift tines to locate the dunnage underneath pallets (e.g., distance rangefinders, optical sensors, etc.). Further, in some cases, the vehicle may also detect dunnage without cargo with sufficient accuracy to be able to autonomously drop cargo off on the dunnage in unloading operations. Additionally, in cases where a pallet has integrated dunnage (e.g., a standard cargo wooden pallet), or in cases where a container has integrated lift points (e.g., for fork placement at the top, bottom, or sides of the container), the vehicle may detect proper locations for placement of the fork tines. At 1220, the vehicle may determine routing and fork placement to lift cargo. At 1225, the vehicle may be positioned to approach the cargo and pick up the cargo. When dropping off the cargo, the vehicle may autonomously drive to the desired location and lower the cargo or otherwise place the cargo at the desired location. In some cases, such as illustrated in FIG. 13, the vehicle may drive up a ramp to load or unload cargo. In other cases, cross-decking operations may be performed and the vehicle may be moved to the proper location and fork assembly moved to the proper height to allow for loading/unloading with the cross-decking surface (e.g., an aircraft deck or conveyer). FIGS. 14 and 15 illustrate movement of non-palletized cargo and also stacking of cargo. In some cases, stacking of cargo may be selected by an operator and/or the vehicle may sense that the cargo is stackable (e.g., using a 3D model database of detected cargo or based on a cargo identifier that indicates stacking capability and a how many stacked layers may be present, programmed cargo movement operations, etc.). FIG. 16A illustrates a forklift vehicle as discussed herein loaded onto an aircraft, such that additional cargo may be loaded onto the aircraft compared with traditional forklifts having similar lift capacity (e.g., as illustrated in FIG. 16B).

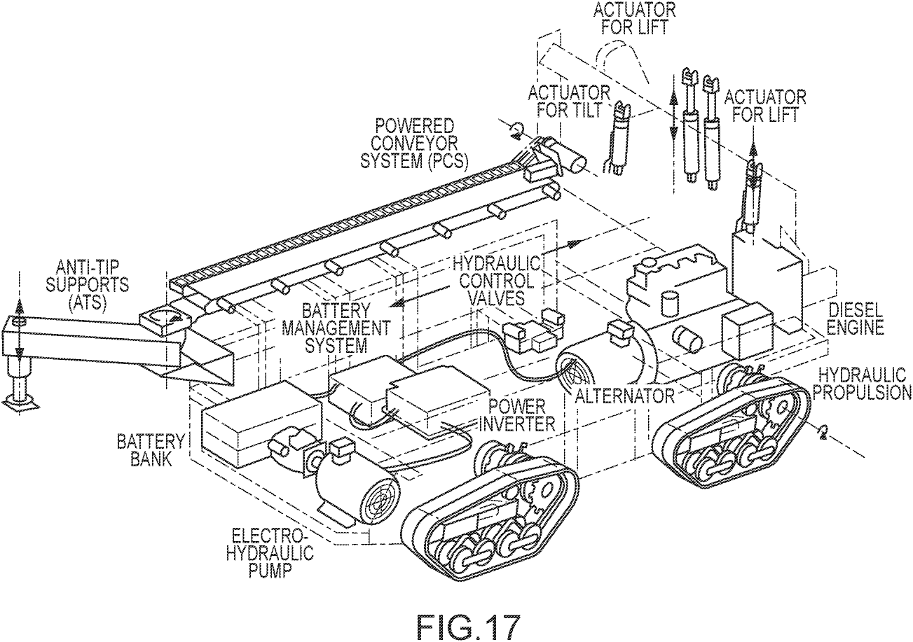

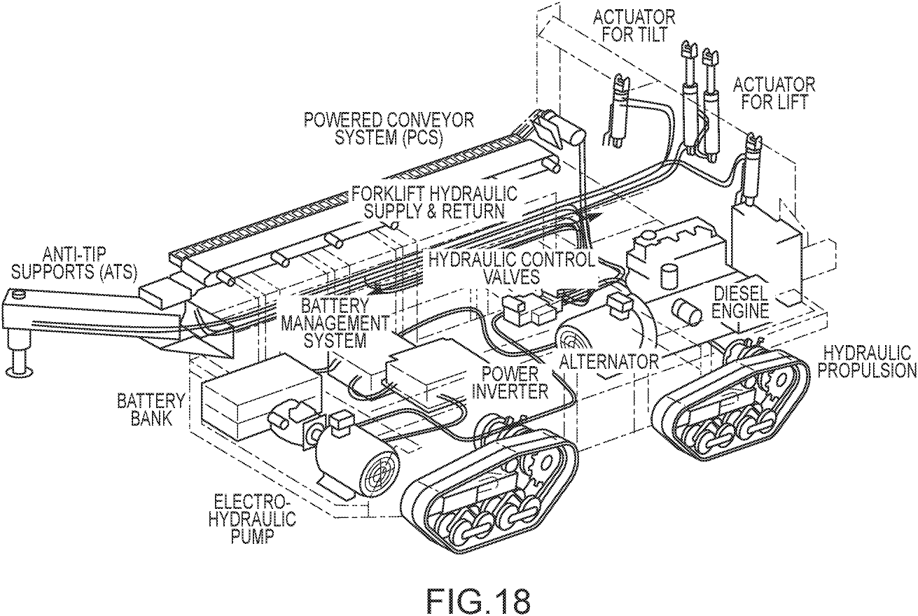

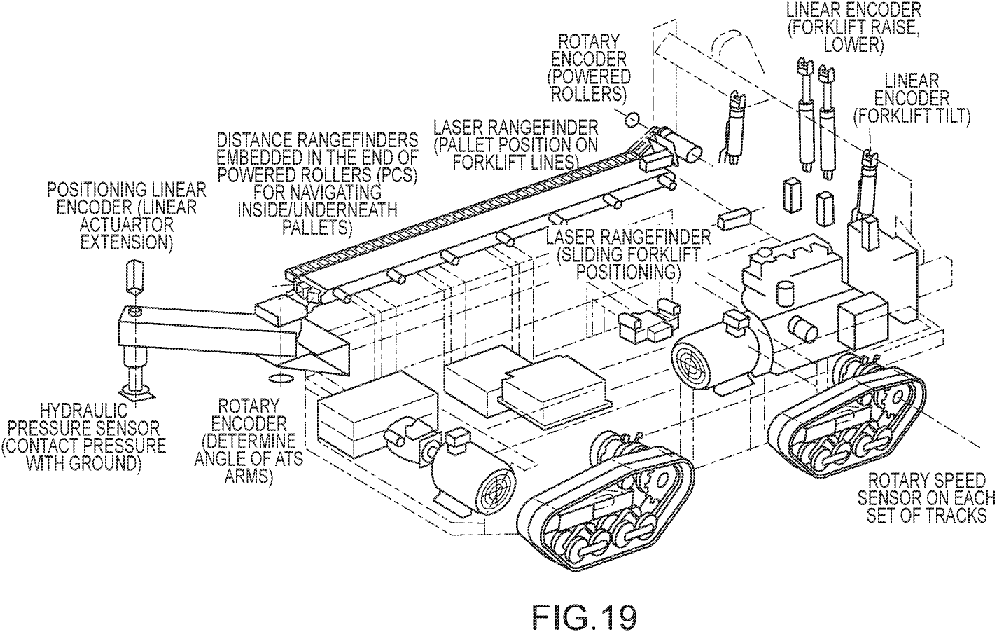

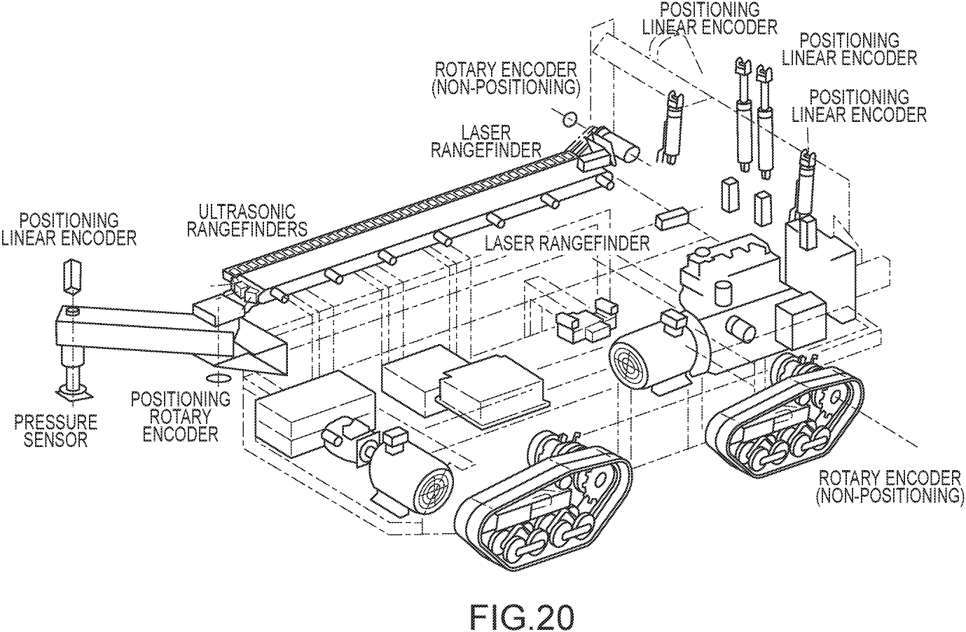

As discussed herein, a cargo transport system may perform a number of functions that provide for efficient handling and movement of cargo, including sensing cargo with varying shape, size, and positioning to enable autonomous manipulation of cargo. The system may also sense an aircraft (or other cargo drop-off points) with sufficient accuracy to determine whether it is in the cross-decking configuration (for loading and unloading cargo only) or in the ramped position for driving into the aircraft. This ensures that the vehicle does not perform the wrong behavior and damage the aircraft or other cargo moving devices. FIGS. 17 through 20 illustrate a cargo transport system and associated components and sensors that provide for vehicle movement, sensing, and control. Such systems provide advantages over existing commercial cargo moving devices that do not currently combine the ability to travel fully-autonomously, over outdoor rough terrain, and with cargo that is both heavy (e.g., 10,000 lbs.) and bulky (e.g., 108″ x 88″). Additionally, most commercial autonomous vehicles have limited autonomous capabilities. Automated Guided Vehicles (AGVs) require a robust route guiding infrastructure (visual markings, rails, wires, lasers, magnetic tape on the ground, etc.) so they are only capable of operating along consistent, repeatable, and dedicated routes. Various aspects as discussed herein provide for autonomy and for indoor and outdoor use, transitions between indoor and outdoor locations (including driving in and out of warehouses, trucks, etc.), operation over rough terrain, relatively heavy lift capability (e.g., 10,000 lbs. of bulky cargo (larger than 60″ x 60″ footprint)), the ability to autonomously operate inside or around active aircraft, including driving in and out of aircraft, among others, which provides for efficient and safe cargo movement. Further, systems discussed herein may autonomously drive up and down steep grades (aircraft cargo ramps, cargo boat ramps/wharfs, cargo truck/trainer ramps, hilly terrain, etc.). Additionally, traditional forklifts with a similar lift capacity require counterweights to manipulate heavy payloads and often weigh upwards of 30,000 lbs, and the vehicle in various examples provided herein may weigh approximately 10,000 lbs - 11,000 lbs, which is a substantial advantage when transporting the vehicle along with cargo (e.g., in an aircraft or over soft terrain such as loose dirt or sand). The anti-tip system enables the vehicle to remain relatively lightweight compared with its payload capacity. In some cases, the cargo transport system may provide for autonomous driving via GPS wayfinding and object detection & object avoidance (OD/OA), alone or in a fleet of multiple vehicles. In some cases, the sensor suite and controller may provide information related to one or a combination of the following:
Vehicle height - which may be calculated with actuator position sensors, and/or using downward pointing LIDAR systems;
Motor speed - which may be calculated using encoders on the motor and/or freewheel;
Track angle - which may be calculated with data from one or more tilt sensors on the track of each propulsion unit, and/or through the use of encoders on a track bearing;
Vehicle orientation - which may be calculated based on data from tilt sensors, a GPS, and/or an IMU;
Vehicle speed - which may be calculated based on data from a ground speed sensor and/or encoders associated with each propulsion unit. In some examples, GPS data may also provide vehicle speed, and LIDAR also may provide speed data as well;
Vehicle location - which may be calculated based on GPS data and/or any of the other data as discussed above (and/or data from one or more other positioning systems);
Ramp detection of an aircraft or vehicle ramp, cargo bay, or cargo door - which may be calculated based on LIDAR data to detect ramp edges, and/or other imaging components such as cameras or time of flight cameras;
Collision detection - which may be determined based on LIDAR detection data, sonar, or cameras (time of flight cameras may also provide distance data to prevent collisions).
Cargo position detection - which may be calculated based on GPS data and/or any of the other data, as discussed above (and/or data from one or more other positioning systems);
Cargo weighing and stability detection - which may be calculated based on data from load cells, strain gauges, and/or any of the other data, as discussed above;
Powered forklift conveyor speed and position - which may be calculated based on data from encoders, proximity sensors, pressure sensors, and/or any of the other data, as discussed above;
Anti-tip system speed, position, and orientation - which may be calculated based on data from encoders, proximity sensors, pressure sensors, and/or any of the other data, as discussed above.

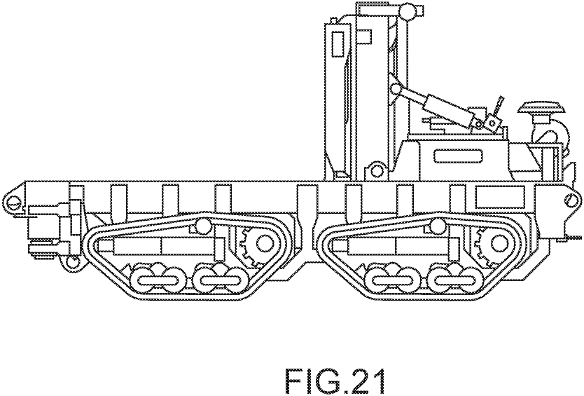

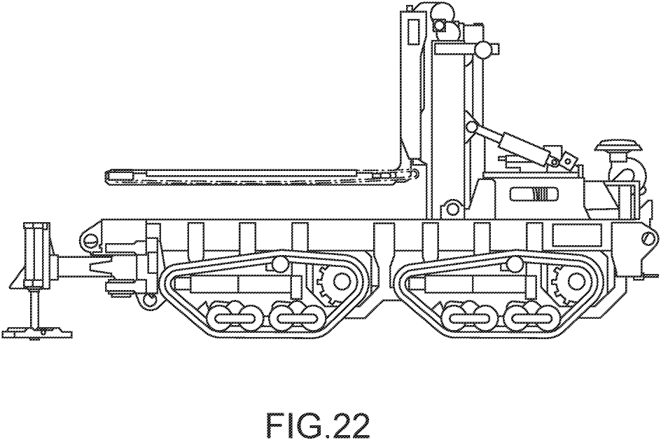

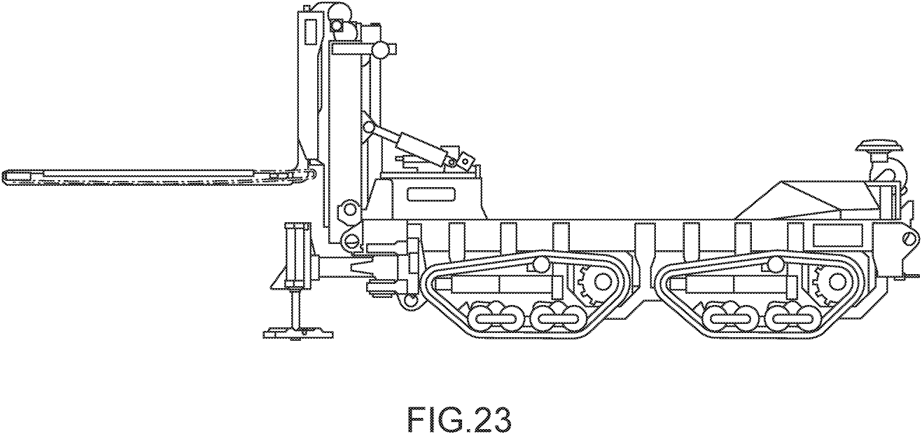

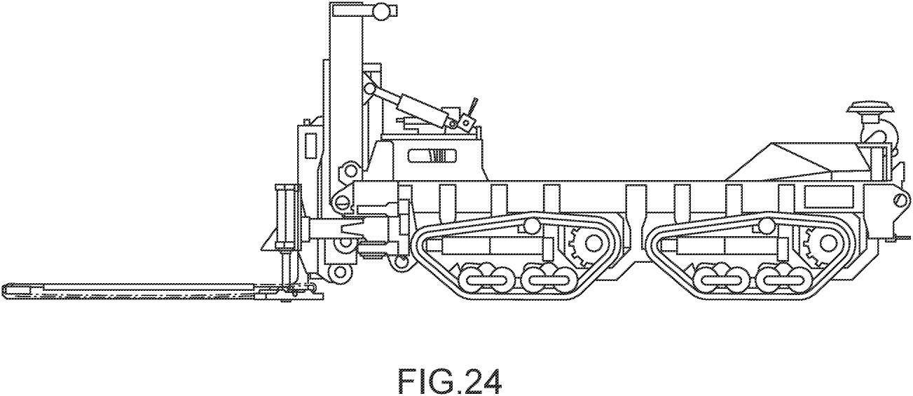

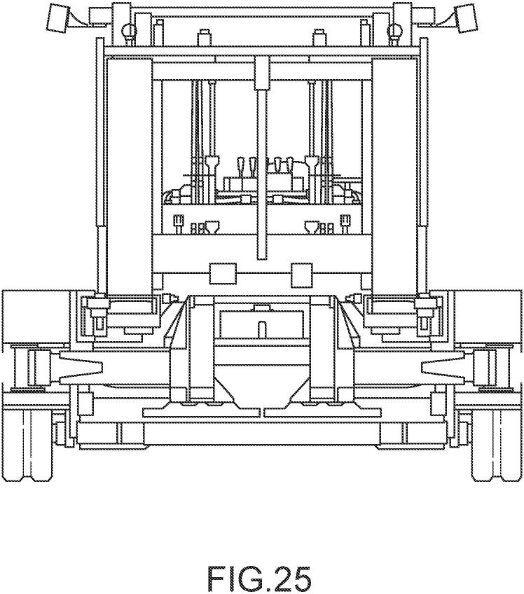

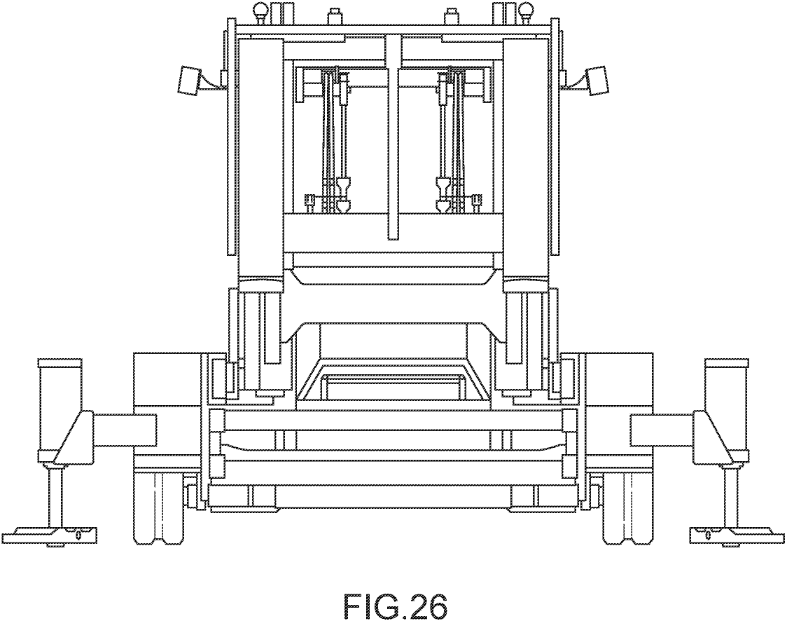

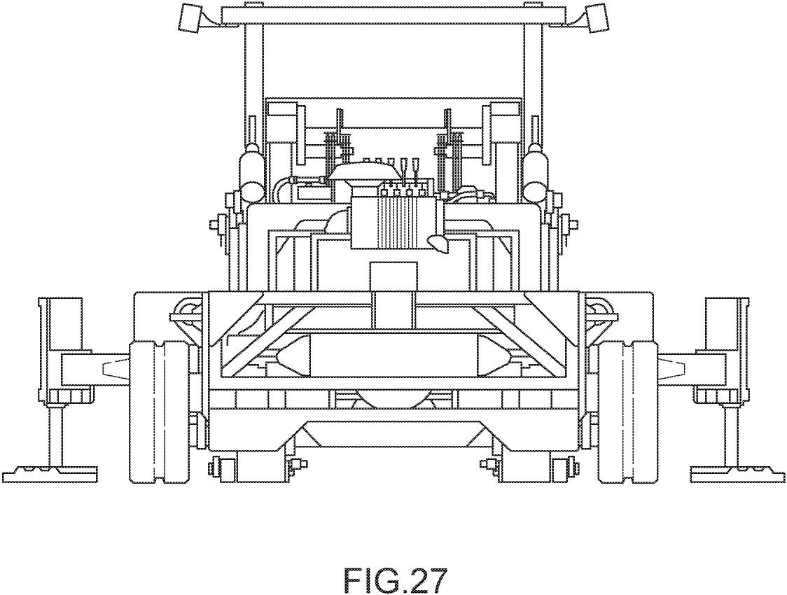

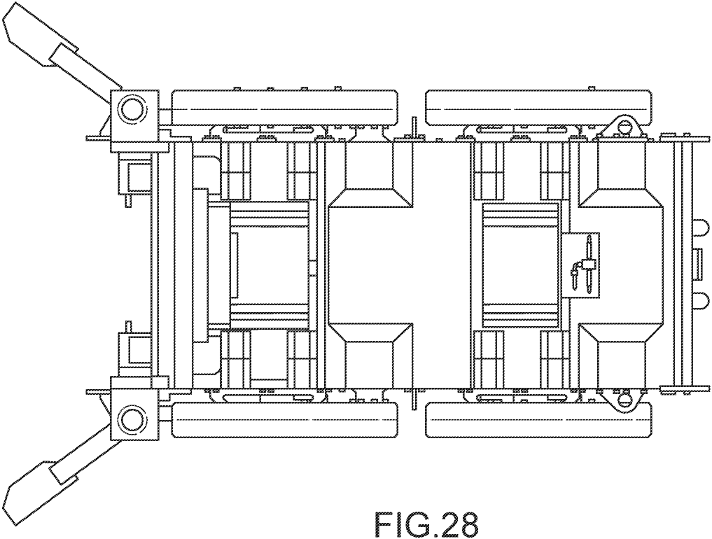

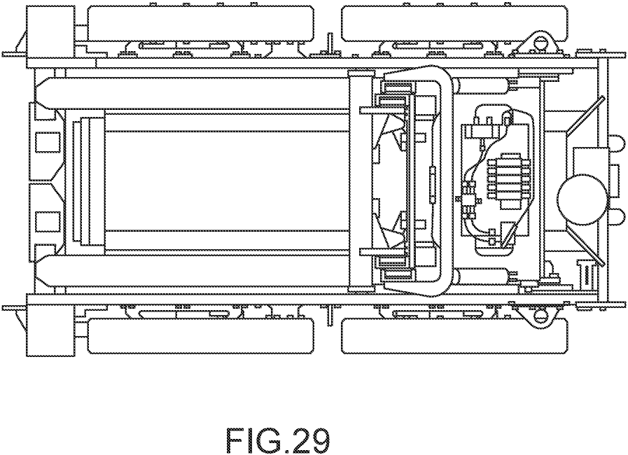

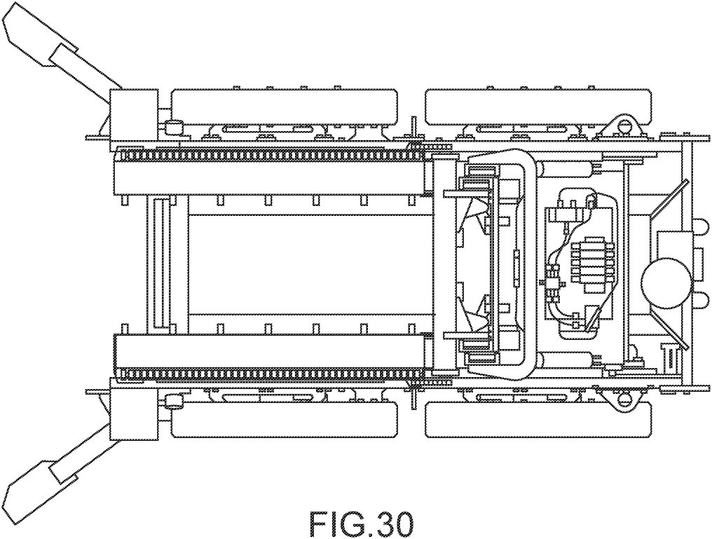

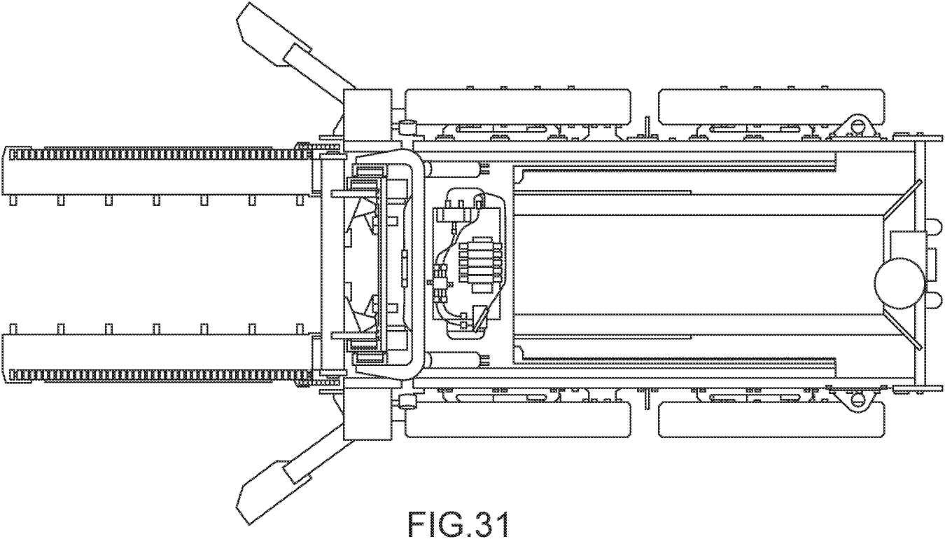

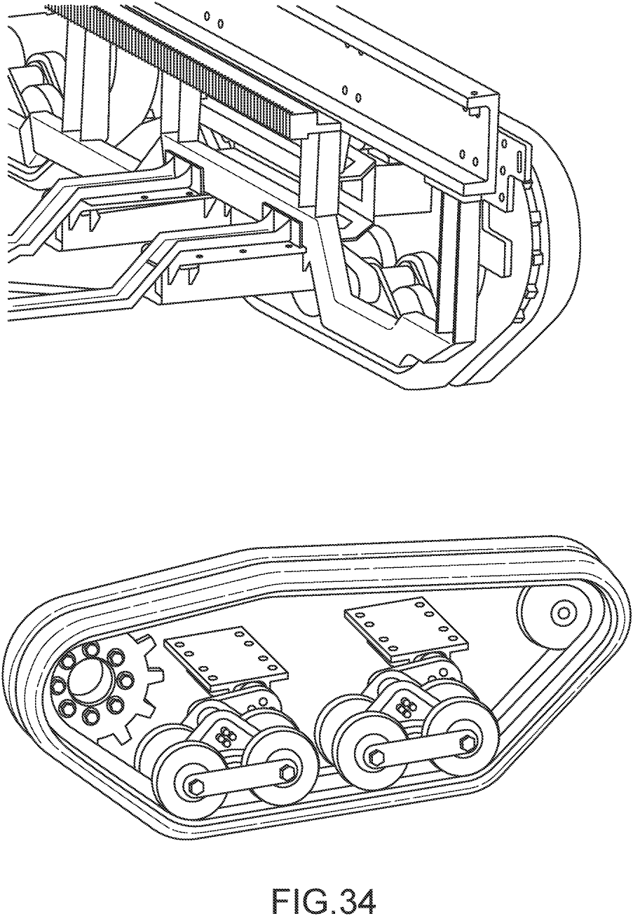

FIGS. 21 through 34 illustrate an exemplary cargo transport system from a number of different perspectives and in a number of different configurations, including right side views of FIGS. 21-24, front views of FIGS. 25-26, rear view of FIG. 27, bottom view of FIG. 28, top views of FIGS. 29-31, and a front perspective view with a cargo load of FIG. 32. FIG. 33 illustrates a wheeled version of an exemplary cargo transport system, and FIG. 34 illustrates a track and associated mounting assembly for securing the track to the vehicle chassis. In this example, the illustrated cargo transport system is a forklift system with a mast that moves vertically up and down from the ground up to about 50 inches, tilts about 10° up and down, has 72″ tines, and is rated for a capacity of 10,000 lbs at a 54″ load center (whereas the industry standard weight capacity is measured at a 24″ load center). The system uses a diesel-electric hybrid system, provides autonomous smooth control of a hydraulic drivetrain, autonomous smooth control of a hydraulic “gear shifting”, and provides autonomous or remote controlled driving in and out of 18-wheeler trailers, CONEX boxes, rectangular enclosed environments, aircraft, and the like.

It should be noted that the systems and devices discussed above are intended merely to be examples. It must be stressed that various embodiments may omit, substitute, or add various procedures or components as appropriate. For instance, it should be appreciated that, in alternative embodiments, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, structures, and techniques have been shown without unnecessary detail in order to avoid obscuring the embodiments.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A cargo transport apparatus, comprising:
a vehicle chassis;
a mast coupled with the vehicle chassis;
a fork assembly movably coupled with the mast, the mast configured to raise and lower the fork assembly;
one or more propulsion units coupled with the vehicle chassis, each of the propulsion units coupled with a power source and configured to move the cargo transport apparatus on a driving surface; and
a controller coupled with the fork assembly and mast, and each of the one or more propulsion units to control movement of cargo by the cargo transport apparatus based at least in part on input from a sensor suite that provides an indication of a location of a raised surface above the driving surface for autonomous or semi-autonomous loading or unloading of the cargo onto and off of the fork assembly when the cargo transport apparatus operates in a cross-decking or stacking operation for cargo handling onto and off of the raised surface.

2. The cargo transport apparatus of claim 1, wherein the raised surface is associated with an aircraft or warehouse conveyer system.

3. The cargo transport apparatus of claim 1, wherein the controller determines a proper location and a proper height of the fork assembly to allow for loading or unloading the cargo onto or off of the raised surface.

4. The cargo transport apparatus of claim 3, wherein the sensor suite includes one or more dense 3D sensors, and the controller determines the proper location and the proper height for the fork assembly based at least in part on input from the one or more dense 3D sensors and a 3D model database associated with the raised surface.

5. The cargo transport apparatus of claim 1, wherein the raised surface is associated with a different cargo item, and the controller determines cargo movement for a stacking operation in which multiple cargo items are stacked.

6. The cargo transport apparatus of claim 5, wherein the multiple cargo items are nonpalletized cargo.

7. The cargo transport apparatus of claim 5, wherein the sensor suite includes one or more dense 3D sensors, and the controller detects the different cargo item based at least in part on input from the one or more dense 3D sensors, and determines the cargo is to be stacked based at least in part on one or more of a 3D model database of cargo types, a cargo identifier that indicates stacking capability, how many stacked layers are supported, programmed cargo movement operations, or any combinations thereof.

8. The cargo transport apparatus of claim 7, wherein the one or more dense 3D sensors provide information to the controller to generate a 3D image of the detected cargo item that is compared to one or more 3D models of the 3D model database to classify the detected cargo item and determine a proper lift orientation for the stacking operation.

9. The cargo transport apparatus of claim 7, wherein the cargo identifier comprises one or more of an optical marker or an electronic marker that is detectable by the controller based on input from the sensor suite.

10. The cargo transport apparatus of claim 9, wherein the optical marker or the electronic marker is attached to the detected cargo item and indicates one or more of an orientation of the detected cargo item, a cargo type of the detected cargo item, an identifier of the detected cargo item, a weight of the detected cargo item, physical dimensions of the detected cargo item, or any combinations thereof.

11. The cargo transport apparatus of claim 1, wherein the sensor suite comprises:
one or more stereographic imaging sensors;
one or more ultrasonic sensors;
one or more LIDAR or 3D flash LIDAR sensors;
one or more radar sensors;
one or more optical sensors coupled with an image processing and recognition system;
or any combinations thereof.

12. The cargo transport apparatus of claim 1, further comprising:
a powered roller assembly coupled with the fork assembly that moves the cargo on the fork assembly away from or toward the mast, and wherein the controller autonomously activates the powered roller assembly to move the cargo onto or off of the fork assembly when one or more sensors of the sensor suite indicate at least a first fork of the fork assembly is located at a proper position for the cross-decking or stacking operation.

13. The cargo transport apparatus of claim 1, further comprising:
a platform coupled with the vehicle chassis, wherein the mast is movably coupled with the platform to move the fork assembly between a forward location at which the fork assembly is movable above or below a top plane of the platform and a rearward location at which the fork assembly is movable above the top plane.

14. A method for transporting cargo using a cargo transport apparatus, comprising:
identifying cargo that is to be transported using the cargo transport apparatus, wherein the cargo transport apparatus is adapted to transport the cargo via a driving surface from a first location to a second location;
aligning a fork assembly of the cargo transport apparatus relative to the cargo on a loading surface based at least in part on input from a sensor suite that provides an indication of a location of the cargo for autonomous or semi-autonomous loading of the cargo onto the fork assembly;
loading the cargo onto the fork assembly;
transporting the cargo to the second location;
aligning a fork assembly of the cargo transport apparatus relative to an unloading surface at the second location at least in part on input from the sensor suite that provides an indication of a location of the unloading surface for autonomous or semi-autonomous unloading of the cargo off of the fork assembly; and
unloading the cargo off of the fork assembly at the second location, wherein one or both of the loading surface or the unloading surface is a raised surface above the driving surface in a cross-decking or stacking configuration.

15. The method of claim 14, wherein the raised surface is associated with an aircraft or warehouse conveyer system.

16. The method of claim 14, wherein the aligning the fork assembly of the cargo transport apparatus relative to the unloading surface comprises:
determining, based at least in part on input from the sensor suite, a proper location and a proper height of the fork assembly to allow for unloading the cargo off of the fork assembly and onto the unloading surface, wherein the unloading surface is at a higher height than the driving surface.

17. The method of claim 16, wherein the sensor suite includes one or more dense 3D sensors, and the proper location and the proper height for the fork assembly is based at least in part on input from the one or more dense 3D sensors and a 3D model database associated with the unloading surface.

18. The method of claim 14, wherein the unloading surface is associated with a different cargo item, and the method further comprises:
determining cargo movement for a stacking operation in which multiple cargo items are stacked.

19. The method of claim 18, wherein the sensor suite includes one or more dense 3D sensors, and the different cargo item is detected based at least in part on input from the one or more dense 3D sensors, and wherein the method further comprises:
determining cargo items are to be stacked based at least in part on one or more of a 3D model database of cargo types, a cargo identifier that indicates stacking capability, how many stacked layers are supported, programmed cargo movement operations, or any combinations thereof.

20. The method of claim 19, further comprising:
generating, based at least in part on input from the one or more dense 3D sensors, a 3D image of the detected cargo item;
comparing the 3D image of the detected cargo item to one or more 3D models of the 3D model database to identify a corresponding 3D model; and
classifying the detected cargo item based at least in part on the corresponding 3D model to determine a proper lift orientation for the stacking operation, and wherein the aligning the fork assembly of the cargo transport apparatus relative to the unloading surface is based at least in part on the determined proper lift orientation.
